(19) United States
(12) Patent Application Publication
(10) Pub. No.: US 2006/0003194 A1
(43) Pub. Date: Jan. 5, 2006

(54) Fuel cell pack and power producing device comprising said fuel cell pack

(76) Inventors: Pierre Charlat, Lans En Vercors (FR); Thierry Novel, Bernin (FR); Frederic Touvard, Meylan (FR)

Correspondence Address: Air Liquide;Intellectual Property Department, 2700 Post Oak Blvd, Suite 1800, Houston, TX, 77056, US

(21) Appl. No.: 10/523,671

(22) PCT Filed: Jul. 18, 2003
(86) PCT No.: PCT/FR03/02279

§ 371 Date: Feb. 1, 2005

(30) Foreign Application Priority Data
Aug. 2, 2002 (FR) 02/09861

(51) Int. Cl. H01M 8/00

(52) U.S. Cl. 429/12; 429/34

(57) ABSTRACT

A fuel cell pack and a power producing device based upon a fuel cell. The fuel cell is made up of a series of elementary cells and a fluid distribution system which makes it possible to feed each cell with two different fluids and to remove the fluids from the cells. The fuel cell pack is provided with a first valve system which interacts with a second valve system present in the power producing device.

The present invention relates to a fuel cell pack and also to a power-producing device comprising at least one such fuel cell pack.

Conventionally, such a power-producing device comprises at least one fuel cell pack, each of which includes a succession of elementary cells arranged beside one another. Each of these cells defines an anode compartment in which the oxidation of hydrogen takes place, and also a cathode compartment in which the oxygen in air is reduced, with water being produced.

Furthermore, an ion-exchange membrane physically separates the anode and cathode compartments of a cell in question, these compartments also being connected by means of an external electrical circuit.

The cell pack is additionally provided with distribution means allowing the various fluids to be fed in and discharged.

Thus, the anode compartment of each cell is placed in communication with a hydrogen inlet line and also with a line for discharging the consumed hydrogen. The latter is mixed with a fraction of water, produced at the cathode, which has crossed the aforementioned separation membrane.

Similarly, the cathode compartment is provided with an air inlet pipe and also with a pipe for discharging this oxygen-depleted air mixed with water.

In order for these fluids to be fed into and discharged from the fuel cell pack, the power-producing device is provided with various members allowing distribution of these fluids.

Thus, in the known prior art, there are provided a plurality of disparate connectors cooperating with fluid inlets and outlets which are present on a number of sides of the cell pack. Moreover, valves enable these various fluid circuits to be closed so as to isolate this cell pack.

However, in the event of failure of a cell pack, it is important to be able to disconnect it from the other elements of the power-producing device in order to provide a rapid replacement thereof.

It will be appreciated that, in the prior art, this operation of disconnecting the cell pack is particularly long and tedious to implement. Thus, the phases of fitting and removing this pack, which are long and tedious, constitute a major portion of the maintenance costs for the power-producing device.

Moreover, this substantial maintenance time is accompanied by a dead period in which the installation is immobilized, during which period the power-producing device based on a fuel cell cannot be used. This constitutes an economic limitation, the impact of which is notable.

The invention proposes to overcome the disadvantages of the prior art mentioned above. It aims particularly to provide a fuel cell pack whose overall maintenance can be achieved much more readily and quickly than by the solutions of the prior art, particularly by facilitating the operations of fitting/removing the cell pack, for example with regard to changing elementary cells.

To this end, the subject of the invention is a fuel cell pack intended to be integrated into a power-producing device, this cell pack comprising a plurality of elementary cells and also fluid distribution means which make it possible to supply each cell with two input fluids, typically hydrogen and air, and also to discharge from these cells two output fluids, typically hydrogen and oxygen-depleted air, these distribution means being able to be connected to a fluid distribution system belonging to said power-producing device, in which fuel cell pack the distribution means comprise, on one side of the cell pack, a series of first valve elements which are able, in the assembled configuration, to cooperate with a series of second valve elements borne by the fluid distribution system.

According to other characteristics of the invention:
the first valve elements are arranged on the same face of the cell pack;
the valve elements have main directions which are parallel to one another.

According to one aspect of the invention, the cell pack combines, at one end, at least two pairs of fluid distribution connectors which are able to cooperate with at least two pairs of stationary, corresponding connectors arranged on the fluid distribution system of the power-producing device.

Another subject of the invention is a power-producing device comprising at least one cell pack and also a fluid distribution system which is able to supply the or each cell pack with two input fluids and also to discharge at least two output fluids coming from this cell pack, this distribution system being able to be connected to external circuits for supplying the input fluids and also for discharging the output fluids, wherein the or each cell pack is as defined above and herein said power-producing device also comprises second valve elements, each second valve element being able to cooperate with a corresponding first valve element with which said cell pack is provided.

According to other characteristics of the invention:
the fluid distribution system comprises a support member, in particular a plate structure, on which are mounted various members for distributing the input and output fluids and which is advantageously made of a plastic by injection molding or compression molding;
the support member has integrated channels cut into it which allow the various fluids to circulate.

The invention will be better understood on reading the description below, which is given purely by way of nonlimiting example and with reference to the appended drawings, in which:

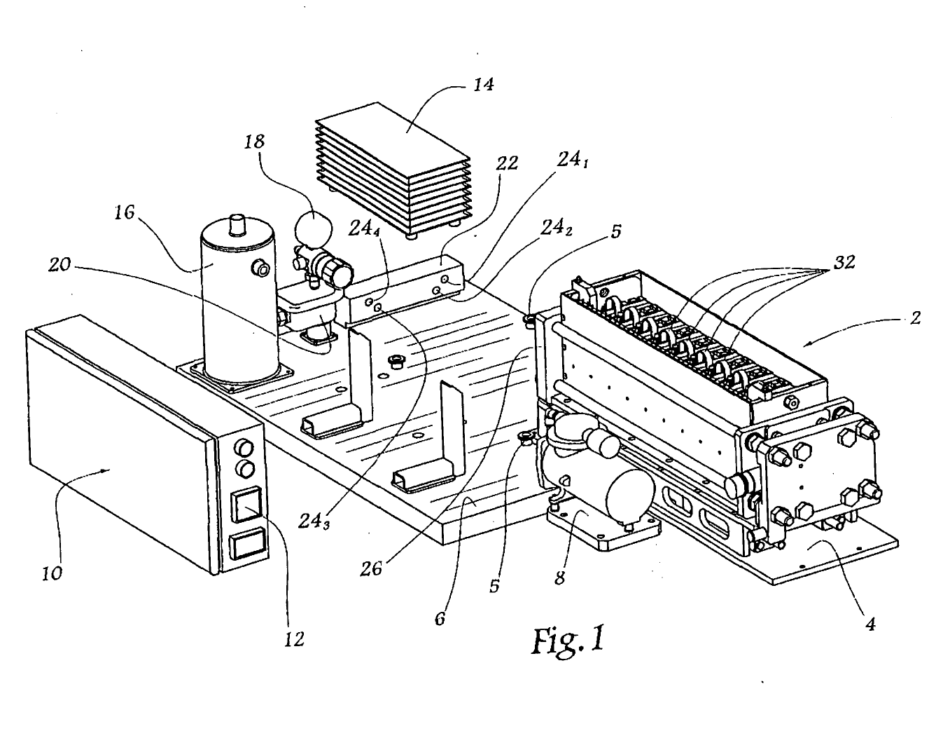

FIG. 1 is an exploded perspective view illustrating the various elements constituting an embodiment of a power-producing device based on a fuel cell, according to the invention;

FIG. 1A is a perspective view of the power-producing device of FIG. 1, once mounted, seen from a different angle;

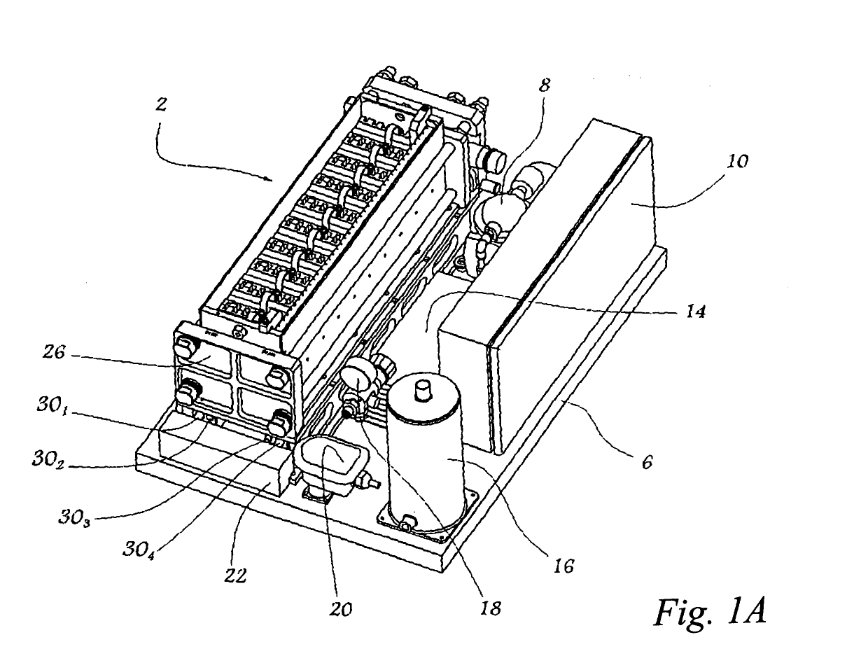

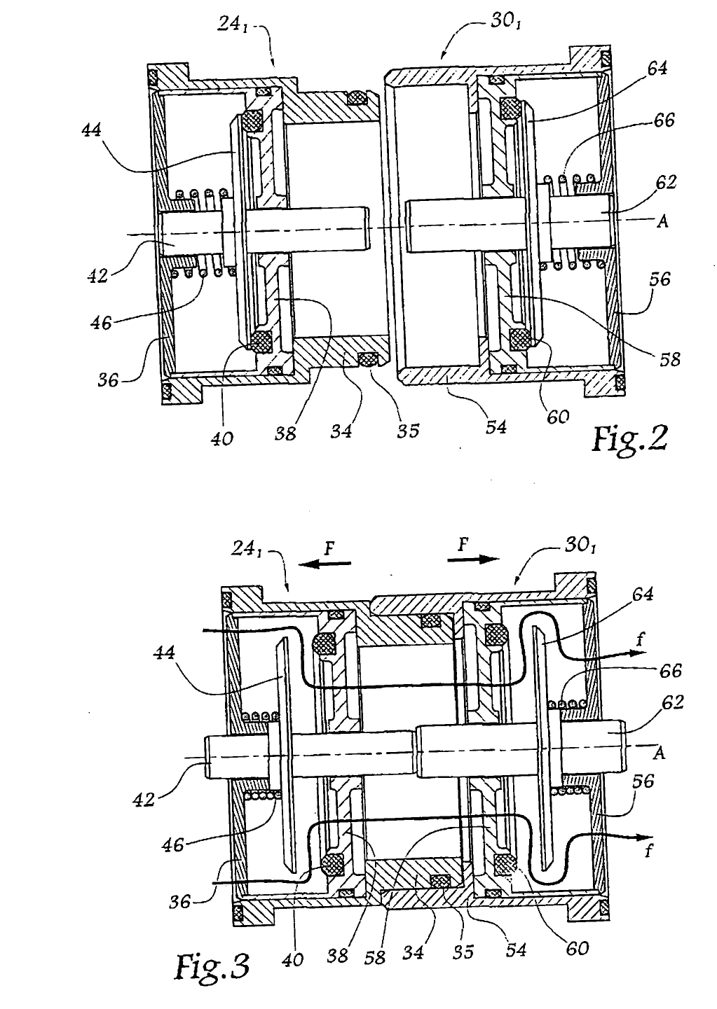

FIGS. 2 and 3 are views in longitudinal section illustrating two valve elements belonging to the power-producing device of the preceding figures, in two different positions; and

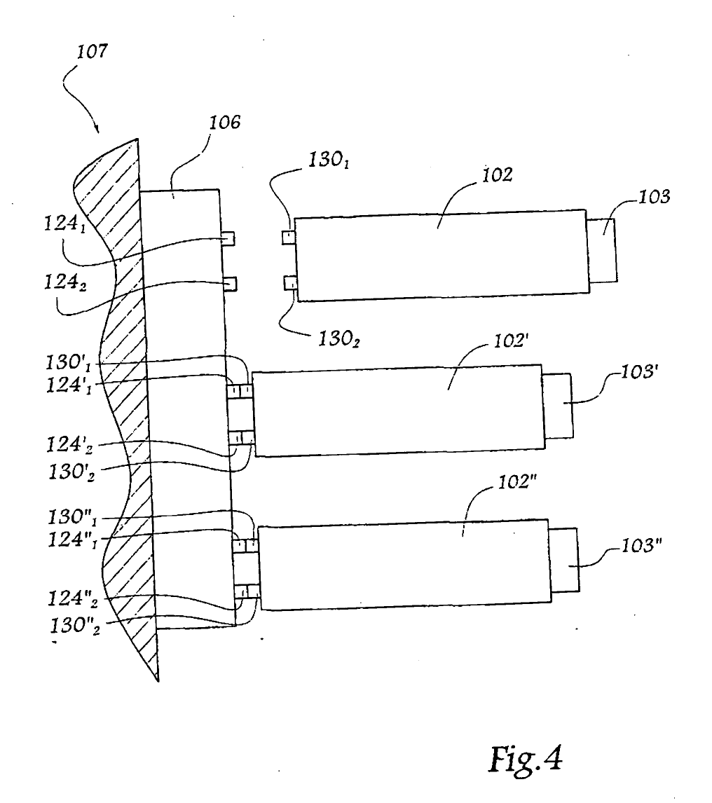

FIG. 4 is a schematic side view illustrating a power-producing device based on a fuel cell, according to a variant embodiment of the invention.

The power-producing device, as illustrated in FIGS. 1 and 1A, comprises a fuel cell pack denoted overall by the reference 2, for example of the type described in the French application filed on Mar. 6, 2002, under number 02 02843, the content of which is incorporated herein by reference.

The cell pack 2 is able to be mounted at its base 4 on a support plate 6 via four centering pegs 5 mounted on the support plate 6. This support plate 6 also houses, in the example represented, a compressor 8, an electrical box 10 provided with its control 12, an air/air exchanger 14, a liquid/gas separator 16, a hydrogen input pressure-reducing valve 18 and also a solenoid valve 20. All these elements, which are of a type known per se, are fixed to the support plate 6 by any suitable means.

The device additionally comprises a fluid connection unit 22, also mounted on the support plate 6, provided with several, typically four, valve elements or closable connectors 24, to 244 arranged in a defined pattern on one face (the front face in FIG. 1) of this unit 22, at the outlet of four orifices in this unit. These various valve elements will be described in more detail hereinafter.

The plate 6 is provided with various orifices which are placed in communication with circuits (not shown) allowing the various fluids to be admitted and discharged.

Moreover, some of the elements 8, 14, 16, 18 and 20 are placed in mutual fluid communication by way of channels (not shown) which are formed in the support plate.

Consequently, air is admitted into a corresponding inlet orifice provided in the plate 6. It then circulates inside this plate, enters the compressor 8 and then leaves the latter to circulate once more within the plate 6, after it has passed through the exchanger 14.

Next, this input air is admitted into the separator 16, leaves therefrom so as to travel within the plate 6, and is then finally brought into the unit 22. It then emerges into a suitable orifice in this connection unit 22 so as to be admitted into the cell pack 2 for the purpose of supplying its various cells with air. Then, the oxygen-depleted air discharged from these cells is once more directed toward the unit 22 via another orifice designated for this air output. This depleted air then circulates inside the plate 6, is admitted into the exchanger 14, leaves the latter, circulates once more within the plate 6, and is finally discharged from the latter through an ad hoc orifice (not shown).

The hydrogen is admitted similarly into the plate 6 through an inlet orifice and then emerges into the connection unit 22. It leaves the latter, via a designated orifice, so as to be admitted into the cell pack 2 for the purpose of supplying the various cells of the latter with hydrogen. Then, the output hydrogen coming from these cells is discharged from the cell pack 2 and enters the connection unit 22 through another designated orifice provided in the latter. This hydrogen then travels inside the plate 6, within the solenoid valve 20, leaves therefrom to circulate once more within the plate, and is finally discharged from this plate via a corresponding outlet orifice (not shown).

The fuel cell pack is for its part equipped at its end with a plate 26 allowing it to be retained mechanically. This plate 26 also performs a fluid connection function. To be specific it is provided, in the vicinity of its lower end, with four closable connectors or valve elements 30₁ to 30₄ (30ᵢ) distributed spatially in a pattern which is identical to that of the valve elements 24ᵢ of the unit 22. The valve elements 30ᵢ are placed at the outlet of four orifices, each of which is intended for the admission or discharge of air or of hydrogen into or from the cell pack. More precisely, these four orifices are placed in communication with means formed in the cell pack 2 which allow fluid to be distributed to and from the various cells 32 of this pack. These distribution means thereby ensure, in a manner known per se, that hydrogen is fed in and discharged and also that air is fed in and oxygen-depleted air is discharged.

FIGS. 2 and 3 illustrate two valve elements 24, and 301, belonging respectively to the unit 22 and to the connection plate 26 with which the cell pack 2 is equipped. It should be understood that the valve elements 24₂ to 24₄ are, for example, analogous to that one 24₁ represented, whereas the valve elements 30₂ to 30₄ are analogous to that one 30₁ represented.

The valve element 24₁ comprises a hollow body 34 mounted in a wall (represented partially) of the unit 22. This body, which comprises an end section 36, houses an intermediate partition 38, forming a seat. Furthermore, openings (not shown) are made both in the end section 36 and in the partition 38 in order to ensure selective fluid flow. An O-ring seal 40 is mounted at the periphery of the partition 38, facing the end section 36. Finally, the valve element 24, is equipped with a moving stem 42 having a peripheral ring 44 which can bear against the seal 40.

Finally, a spring 46 is provided, a first end of which bears against the end section 36, while its other end bears against the ring 44. This spring tends to return the latter 44 against the seal 40, namely into the closed position of the valve assembly 241.

The valve element 30₁ also comprises a hollow body 54 which is able to fit over the free end of the body 34 of the element 24₁, with interposition of a peripheral seal 35. The other element 30₁ thus forms the female part of the valve formed by the two elements 24₁ and 30₁.

The body 54, which comprises an end section 56, houses a partition 58, forming a seat, in which an O-ring seal 60 is accommodated. The element 30₁ also includes a stem 62 having an outer ring 64 which can bear against the seal 60.

Openings (not shown) are made in the end section 56 and in the partition 58 in order to allow selective fluid flow.

Finally, a spring 66 is provided, one end of which bears against the end section 56, while its other end bears against the ring 64. This spring 66 tends to return the ring 64 against the seal 60, that is to say into the closed position of the valve element 30₁.

When the cell pack 2 is not mounted on the support plate 6, each valve element 24₁ and 30₁ is in its closed position, illustrated in FIG. 2. Consequently, it is not possible for any fluid to be discharged either from the cell pack 2 or from the fluid connection unit 22. Furthermore, any input of external air is avoided.

If it is wished to bring the power-producing device into service, the cell pack 2 has to be arranged on the support plate 6 and, more precisely, the connection unit 22 has to be engaged with the connection plate 26.

To this end, the cell pack 2 is brought together with the connection unit 22, assumed to be fixed, in the main direction of the valve elements (referenced A in FIGS. 2 and 3), namely the main direction of the hollow bodies 34 or 54. It will be noted that such an operation is made possible by virtue of the fact that, on the one hand, the main axes of the valve elements 30₁ to 30₄ are parallel to one another and that, on the other hand, the main axes of the valve elements 24₁ to 24₄ are also parallel to one another.

During the bringing-together operation mentioned above, the free end of the hollow body 34 enters the inner volume of the hollow body 54, while the two stems 52 and 62 are pushed back toward a facing end wall, 36 or 56 respectively, in the direction of the arrows F.

The rings 44 and 64 are thus moved away from the seals 40 and 60, which releases the openings made in the partitions 38 and 58 and also those made in the end sections 36 and 56. The various fluids are then able to flow within the two valve elements, in the direction of the arrows f.

This therefore guarantees that the cells 32 are supplied simultaneously with air and with hydrogen and also that oxygen-depleted air and hydrogen are discharged from the cell pack 2.

By way of a variant (not shown), the valve element 24, mounted on the connection unit 22 may have only one fluid flow position. In this case, this valve element is fixed, which is advantageous in economic terms since this measure provides a reduction in the manufacturing costs.

It should be noted that such a possibility is not necessarily detrimental to the sound operation of the power-producing device, particularly when such a fixed valve element is intended to receive oxygen-depleted air discharged from the cell pack.

FIG. 4 illustrates a variant embodiment of a power-producing device according to the invention.

Several, in this case three, fuel cell packs which are, for example, identical and are allocated the references 102, 102′ and 102″ are thus provided.

The power-producing device also includes a support plate 106 which is permanently fixed, for example against a wall 107. This plate 106 is provided with the various elements 8 to 20 described with reference to FIGS. 1 and 1A but not represented in this FIG. 4.

The support plate 6 is additionally equipped with three series of four valve elements. There can thus be seen four upper valve elements, of which only two 124₁ and 124₂ are represented, four intermediate valve elements, of which only two 124′₁, and 124′₂ are represented, and also four lower valve elements, of which only two 124″₁ and 124″₂ are represented.

These various valve elements, which are similar to those 24₁ to 24₄, have main axes which are parallel to one another.

Furthermore, the upper cell pack 102 is provided with four valve elements, of which only two 130₁ and 130₂ are represented. These valve elements, which are similar to those 30₁ to 30₄, are able to cooperate with the upper valve elements, in particular 124, and 1242, with which the support plate 106 is provided.

The intermediate cell pack 102′ is also provided with four valve elements, of which only two 130′₁ and 130′₂ are represented. These valve elements, which are similar to those 30₁ to 30₄, are able to cooperate with the intermediate valve elements, in particular 124′₁ and 124′₂, with which the support plate is provided.

Finally, the lower cell pack 102″ is provided with four valve elements, of which only two 130″₁ and 130″₂ are represented. These various valve elements, which are similar to those 30₁ to 30₄, are able to cooperate with the lower valve elements, in particular 124″₁ and 124″₂, with which the support plate 106 is provided.

Each cell pack 102, 102′ and 102″ is, moreover, equipped with a gripping handle 103, 103′ and 103″. Finally, guide means, such as slideways (not shown), may advantageously be provided in order to permit simple positioning of the cell packs when they are being mounted on the support plate 106.

The power-producing device represented in FIG. 4 is particularly convenient to use. Thus, the user is able to disconnect from the support plate 106 one or other of the cell packs 102, 102′ or 102″ in the event of failure. Such an operation is additionally facilitated by the presence of the handles 103, 103′ and 103″.

The invention makes it possible to achieve the objectives mentioned above.

Thus, the or each fuel cell pack with which the power-producing device is equipped can be disconnected in a particularly simple and speedy manner. Consequently, it is much simpler to maintain this power-producing device than in the prior art.

Simplifying maintenance in this way additionally guarantees an increase in productivity. Specifically, since the cell pack is put out of service for a shorter length of time, its effective operating time is correspondingly prolonged.

According to one characteristic of the invention, the support plate 6 or 106, additionally providing circulation of the fluids, is made of a plastic by injection molding or compression molding. It is also conceivable for the major part of the various valve elements with which the cell pack or the fluid connection unit are equipped to be made of such a plastic. In this regard, only the springs, referenced 46 and 66 in FIGS. 2 and 3, are then formed of another material, particularly metal.

This use of a plastic makes it possible to very significantly reduce the various manufacturing costs associated with the power-producing device. Furthermore, this ensures particularly easy maintenance given that it is remarkably simple to take hold of and remove the various constituent elements.

1-16. (canceled)

17. An apparatus which may be used as a fuel cell pack intended to be integrated into a power-producing device, said apparatus comprising:
a) a plurality of elementary cells; and
b) a fluid distribution means, wherein:
1) said fluid distribution means supplies each said elementary cell with two input fluids, and allows for the discharge of two output fluids from said elementary cells;
2) said fluid distribution means is able to be connected to a fluid distribution system of the power-producing device which said apparatus is intended to be integrated with; and
3) said fluid distribution means comprises a series of first valve elements, wherein:
i) said first valve elements are located on a first side of said apparatus; and
ii) when said apparatus is integrated with said power producing device, said first valve elements are able to substantially cooperate with a series of second valve elements located on said fluid distribution system.

18. The apparatus of claim 17, wherein all said first valve elements are arranged on the same face of said apparatus.

19. The apparatus of claim 18, wherein each said first valve element has an axis of symmetry parallel to each other.

20. The apparatus of claim 19, wherein each said first valve element comprises a moving member, wherein said member is able to move in the direction of said axis of symmetry.

21. The apparatus of claim 20, wherein:
a) each said first valve element further comprises a first hollow body;
b) said first hollow body contains both said moving member and a spring; and
c) said spring is able to move said moving member.

22. The apparatus of claim 18, wherein:
a) said first valve elements are located on an end plate of said apparatus; and
b) said end plate provides a mechanical retaining function.

23. An apparatus which may be used as a power-producing device based upon a fuel cell, said apparatus comprising:
a) at least one fuel cell pack, wherein said fuel cell pack comprises:
1) a plurality of elementary cells; and
2) a fluid distribution means, wherein:
i) said fluid distribution means supplies each said elementary cell with two input fluids, and allows for the discharge of two output fluids from said elementary cells;
ii) said fluid distribution means is able to be connected to a fluid distribution system of said apparatus; and
iii) said fluid distribution means comprises at least one series of first valve elements, wherein said first valve elements are located on a first side of said fuel cell pack;
b) said fluid distribution system, wherein:
1) said fluid distribution system is able to supply each said fuel cell pack with said input fluids, and allows for the discharge of at least two said output fluids from each said fuel cell pack; and
2) said fluid distribution system is able to be connected to at least one external circuit for the supply of said input fluids, and to at least one external circuit for the discharge of said output fluids; and
c) at least one series of second valve elements, wherein said second valve elements are able to substantially cooperate with said first valve elements.

24. The apparatus of claim 23, wherein said fluid distribution system further comprises a support member, wherein said support member comprises:
a) at least one fluid input member; and
b) at least one fluid output member.

25. The apparatus of claim 24, wherein said support member is a plate.

26. The apparatus of claim 24, wherein said support member is made of plastic and formed by injection molding or compression molding.

27. The apparatus of claim 24, wherein said support member further comprises integrated channels to allow said fluids to circulate.

28. The apparatus of claim 24, wherein:
a) said fluid distribution system comprises said series of second valve elements; and
b) each said series of second valve elements is able to substantially cooperate with a corresponding said series of first valve elements.

29. The apparatus of claim 23, wherein:
a) each said first valve element comprises a first moving member, wherein said first moving member is able to move in the direction of the axis of symmetry of said first valve element; and
b) each said second valve element comprises an actuating element, wherein said actuating element is able to move said first moving member of the corresponding said first valve element from a closed position to an open position.

30. The apparatus of claim 29, wherein said actuating element is an opening/closing member which is able to move in the direction of the axis of symmetry of said second valve element.

31. The apparatus of claim 30, wherein:
a) each said second valve element comprises a second hollow body;
b) said second hollow body contains both said actuating element and a spring; and
c) said spring is able to move said actuating element.

32. The apparatus of claim 31, wherein:
a) each said first valve element comprises a first hollow body;
b) said first hollow body contains both said moving member and a spring
c) said spring is able to move said moving member.

33. The apparatus of claim 32, wherein a free end of said first hollow body is able to fit into the corresponding said second hollow body.

34. The apparatus of claim 33, wherein a sealing element is located between said first hollow body and said corresponding second hollow body.

35. The apparatus of claim 32, wherein a free end of said second hollow body is able to fit into the corresponding said first hollow body.

36. The apparatus of claim 35, wherein a sealing element is located between said second hollow body and said corresponding first hollow body.

37. The apparatus of claim 23, wherein:
a) a substantial portion of a component is made of plastic formed by injection molding or compression molding; and
b) said component comprises at least one member selected from the group consisting of:
1) said first valve element; and
2) said second valve element.
